(19) United States
(12) Patent Application Publication
(10) Pub. No.: US 2025/0048314 A1
(43) Pub. Date: Feb. 6, 2025

(54) PASSIVE ON-DEMAND POSITIONING METHODS USING BACKHAUL MESSAGING

(71) Applicant: QUALCOMM Incorporated, San Diego, CA (US)

(72) Inventors: Danlu ZHANG, San Diego, CA (US); Srinivas YERRAMALLI, San Diego, CA (US); Alexandros MANOLAKOS, Athens (GR); Arnold Jason GUM, San Diego, CA (US)

(21) Appl. No.: 18/718,151

(22) PCT Filed: Jan. 24, 2023
(86) PCT No.: PCT/US2023/061140

§ 371 Date: Jun. 10, 2024

(30) Foreign Application Priority Data
Feb. 14, 2022 (GR) 20220100138

(51) Int. Cl. H04W 64/00; H04L 5/00; H04W 76/20; H04W 92/18

(52) U.S. Cl. CPC H04W 64/00; H04L 5/0051; H04W 76/20; H04W 92/18

(57) ABSTRACT

Techniques are provided for passive positioning of user equipment (UE) with backhaul messaging. An example method for providing passive positioning information includes transmitting, with a first wireless node, assistance data associated with at least a first reference signal and a second reference signal, transmitting, with the first wireless node, the first reference signal at a first time via one or more over-the-air signals, providing instructions via a wired network connection to enable a second wireless node to transmit the second reference signal at a second time, and transmitting, with the first wireless node, turnaround time information based on the first time and the second time.

### CROSS-REFERENCE TO RELATED APPLICATION

The application claims the benefit of Greek Patent Application No. 20220100138, filed Feb. 14, 2022, entitled “PASSIVE ON-DEMAND POSITIONING METHODS USING BACKHAUL MESSAGING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and a fifth generation (5G) service (e.g., 5G New Radio (NR)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

Obtaining the location of a mobile device that is accessing a wireless network may be useful for many applications including, for example, emergency calls, personal navigation, consumer asset tracking, locating a friend or family member, etc. Existing positioning methods include methods based on measuring radio signals transmitted from a variety of devices including satellite vehicles and terrestrial radio sources in a wireless network such as base stations and access points.

### SUMMARY

An example method for providing passive positioning information according to the disclosure includes transmitting, with a first wireless node, assistance data associated with at least a first reference signal and a second reference signal, transmitting, with the first wireless node, the first reference signal at a first time via one or more over-the-air signals, providing instructions via a wired network connection to enable a second wireless node to transmit the second reference signal at a second time, and transmitting, with the first wireless node, turnaround time information based on the first time and the second time.

Implementations of such a method may include one or more of the following features. The first reference signal and the second reference signal may be downlink positioning reference signals. The assistance data may be transmitted via one or more radio resource control messages. The assistance data may be included in one or more system information blocks. The turnaround time information may be included in the assistance data. The second wireless node may be a transmission/reception point and the instructions are provided directly to the transmission/reception point via an X2 interface. The second wireless node may be a transmission/reception point and the instructions are provided to the transmission/reception point via a location management function. The second wireless node may be a roadside unit and the instructions are configured to enable the roadside unit to transmit the second reference signal via a sidelink. The first reference signal may utilize a first radio access technology and the second reference signal may utilize a second radio access technology that is different from the first radio access technology.

An example of providing on-demand reference signals according to the disclosure includes receiving instructions from a first wireless node to transmit a reference signal, transmitting the reference signal at a first time to a second wireless node, and providing an indication of the first time to the first wireless node.

Implementations of such a method may include one or more of the following features. The instructions may be received from the first wireless node via one or more over-the-air messages. The one or more over-the-air messages may include radio resource control messages. The instructions may be received via a wired network connection. The reference signal may be a sounding reference signal for positioning. The reference signal may be a downlink positioning reference signal. The reference signal may be a sidelink positioning reference signal. The indication of the first time may include providing one or more over-the-air messages to the first wireless node. Providing the indication of the first time may include providing one or more messages to the first wireless node via a wired network connection. The reference signal may be transmitted by a gNB. The reference signal may be transmitted by a user equipment. The reference signal may be transmitted by an integrated access-backhaul node.

An example apparatus according to the disclosure includes a memory, at least one transceiver, at least one processor communicatively coupled to the memory and the at least one transceiver, and configured to: transmit assistance data associated with at least a first reference signal and a second reference signal, transmitting the first reference signal at a first time via one or more over-the-air signals, provide instructions via a wired network connection to enable a wireless node to transmit the second reference signal at a second time, and transmit turnaround time information based on the first time and the second time.

An example apparatus according to the disclosure includes a memory, at least one transceiver, at least one processor communicatively coupled to the memory and the at least one transceiver, configured to: receive instructions from a first wireless node to transmit a reference signal; transmit the reference signal at a first time to a second wireless node; and provide an indication of the first time to the first wireless node.

Items and/or techniques described herein may provide one or more of the following capabilities, as well as other capabilities not mentioned. A first station may transmit a first positioning reference signal at a first time and provide instructions to a second station via a backhaul to transmit at least a second positioning reference signal. The time the second positioning reference signal is transmitted may be based on a preestablished time. The second station may report a time the second reference signal was transmitted. A network server may be configured to coordinate the transmission times for the first and second positioning reference signals. User equipment may be configured to receive the first and second positioning reference signals. A turnaround time associated with the transmission of the first and second positioning reference signals may be provided to the user equipment. A distance between the first and second stations may be provided to the user equipment. The user equipment may determine a time difference of arrival based on the times the first and second positioning reference signals are received, and the turnaround time and distance values. The time difference of arrival may be provided to a network server and the location of the user equipment may be determined. The user equipment may receive assistance data and may determine a location based on the time difference of arrival and the assistance data. The first or second stations may be user equipment. Round trip time procedures may be used to determine a distance between the first and second stations. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment.

FIG. 3 is a block diagram of components of an example transmission/reception point.

FIG. 4 is a block diagram of components of an example server shown in FIG. 1.

FIGS. 5A and 5B illustrate example downlink positioning reference signal resource sets.

FIG. 6 is an illustration of example subframe formats for positioning reference signal transmission.

FIG. 7 is an example round trip time message flow between a user equipment and a base station.

FIG. 8 is an example message flow for an on-demand passive positioning of a user equipment with backhaul messages.

FIG. 9 is an example message flow for on-demand positioning of a user equipment with backhaul messages.

FIG. 10 is an example message flow for on-demand passive positioning of a first user equipment with a base station and a second user equipment.

FIG. 11 is an example message flow for on-demand passive positioning of a user equipment with a plurality of base stations.

FIG. 12 is a process flow for an example method for providing passive positioning information.

FIG. 13 is a process flow for an example method for providing on-demand reference signals.

### DETAILED DESCRIPTION

Techniques are discussed herein for on-demand passive positioning of user equipment (UE) in 5GNR. 5GNR includes several positioning methods such as downlink (DL) and uplink (UL) Time Difference of Arrival (TDOA), DL Angle of Departure (AoD), UL Angle of Arrival (AoA), DL initiated Round Trip Time (RTT), and combinations of these methods. In general, some TDOA methods may require network synchronization. In contrast, RTT based methods are not dependent on network synchronization. Simultaneously positioning user equipment in high density areas (e.g., stadiums, convention centers, Internet of Things (IoT) installations, and Industrial IoT (IIoT), etc.) may present challenges associated with messaging and bandwidth limitations. For example, RTT methods require transmissions from each UE and thus may not be scalable in UE dense environments. DL TDOA based methods, however, with time synchronized NR networks may be scaled to a large number of devices without exceeding bandwidth limitations. For example, fixed overhead positioning reference signal (PRS) transmissions from base stations may be used. The PRS transmissions are independent from the number of UEs and the UEs are not required to transmit responses to the PRS transmissions.

The techniques provided herein utilize passive positioning techniques with a plurality of stations. In an example, backhaul messaging between stations may be used to enable passive positioning of wireless nodes in the network. The utilization of the backhaul messages may reduce the requirements for stations (e.g., gNBs) to receive downlink reference signals. For example, a location server, such as a location management function (LMF), may perform as a central node for a positioning session and may provide positioning reference signal configuration information to network stations. The location server may also be configured to trigger a positioning session. A first station (e.g., gNB) may be designated as a master node and may be configured to initiate the positioning session. The first station may transmit a first PRS to a UE and send request messages over the backhaul to other stations (e.g., gNBs). A second station is configured to receive the request message and then transmit a second PRS to the UE. The second PRS may be transmitted at a designated time as defined in the request message or other network protocols. The UE receives the first and second PRS and records the time interval between the measurements. In an example, the UE may report the time interval to the location server. The UE may also receive location and timing information associated with the first and second stations and the first and second PRS. For example, the time difference between the transmission of the first PRS and the second PRS may be included in assistance data, or other messages, received by the UE. The UE may be configured to utilize the time difference (e.g., reference signal time difference (RSTD)) value to determine a hyperbola based on the locations of the first and second stations. The UE may be configured to derive RSTD values for a plurality of stations to compute a position estimate. These techniques and configurations are examples, and other techniques and configurations may be used.

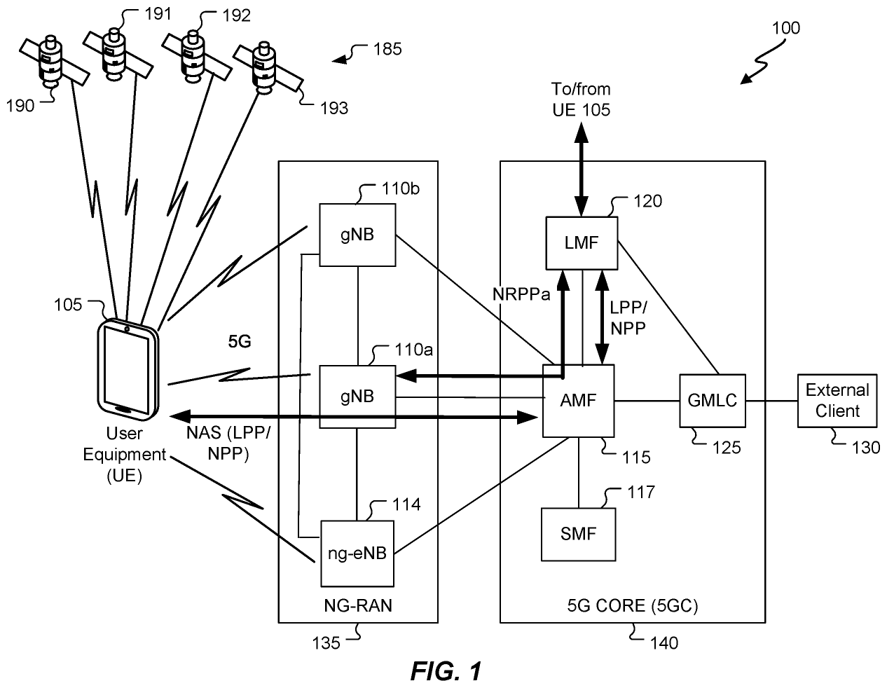

Referring to FIG. 1, an example of a communication system 100 includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs (e.g, gNB 110a, gNB 110b, ng-eNB 114) may each comprise one or more TRPs. For example, each sector within a cell of a BS may comprise a TRP, although multiple TRPs may share one or more components (e.g., share a processor but have separate antennas). The communication system 100 may include macro TRPs or the communication system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications. The LMF 120 may support positioning of the UE 105 when the UE 105 accesses the NG-RAN 135 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120).

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time Of Arrival (TOA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

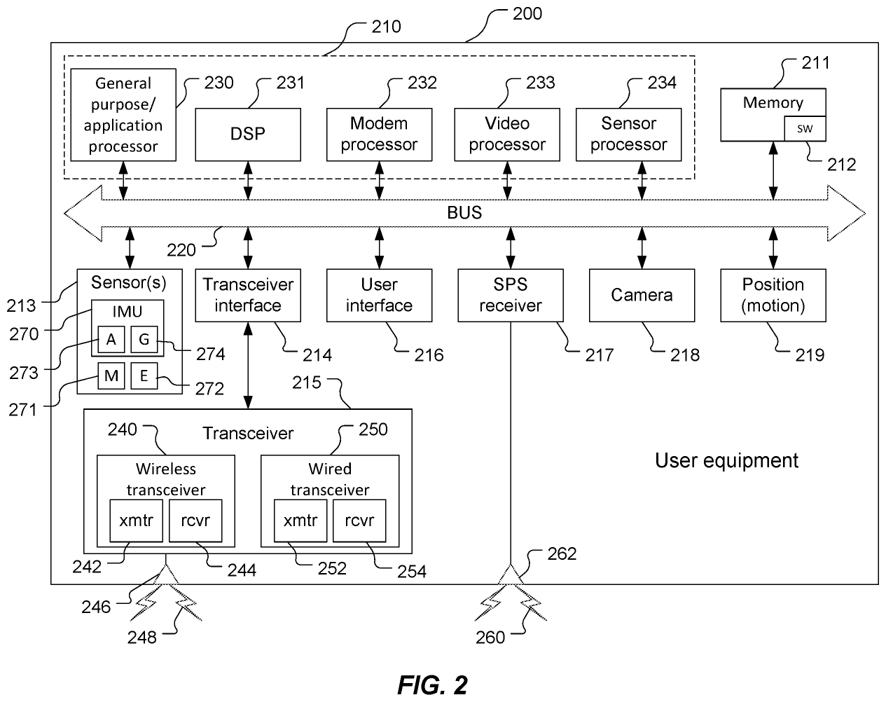

Referring also to FIG. 2, a UE 200 is an example of the UE 105 and comprises a computing platform including a processor 210, memory 211 including software (SW) 212, one or more sensors 213, a transceiver interface 214 for a transceiver 215 (that includes a wireless transceiver 240 and/or wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radio frequency (RF) sensing (with one or more wireless signals transmitted and reflection(s) used to identify, map and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (Vehicle-to-Everything) (PC5), V2C (Uu), IEEE 802.11 (including IEEE 802.11 p), WiFi, WiFi Direct (WiFi-D), Bluetooth®, Zigbee etc. New Radio may use mm-wave frequencies and/or sub-6 GHz frequencies. The wired transceiver 250 may include a transmitter 252 and a receiver 254 configured for wired communication, e.g., with the NG-RAN 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the wireless signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

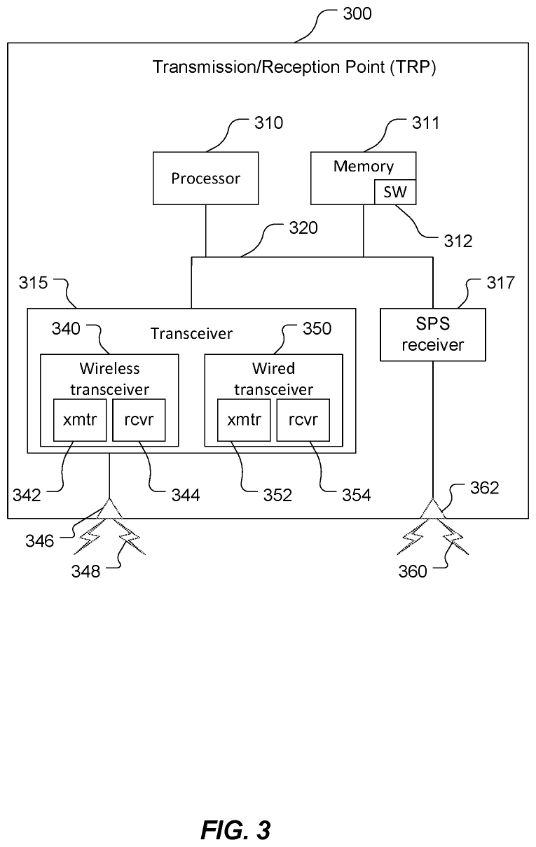

Referring also to FIG. 3, an example of a TRP 300 of the gNB 110a, gNB 110b, ng-eNB 114 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the gNB 110a, gNB 110b, ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels, one or more downlink channels, and/or one or more sidelink channels) and/or receiving (e.g., on one or more downlink channels, one or more uplink channels, and/or one or more sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120 or other network server, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

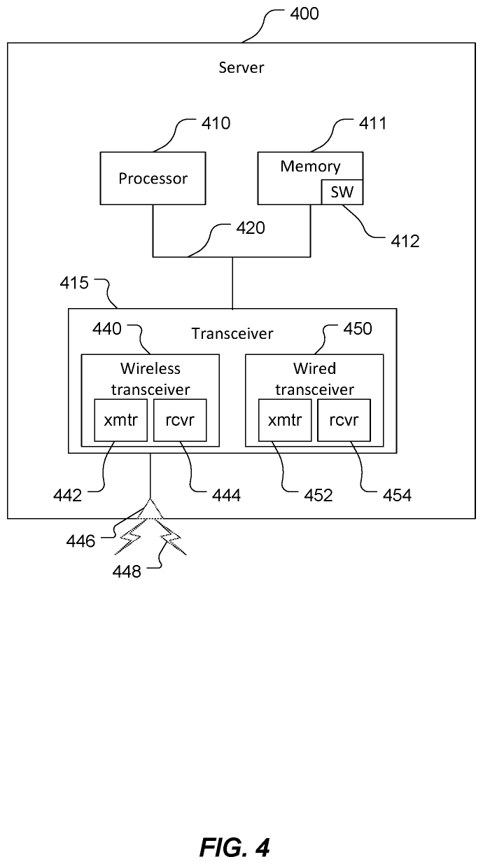

Referring also to FIG. 4, an example server, such as the LMF 120, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the NG-RAN 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

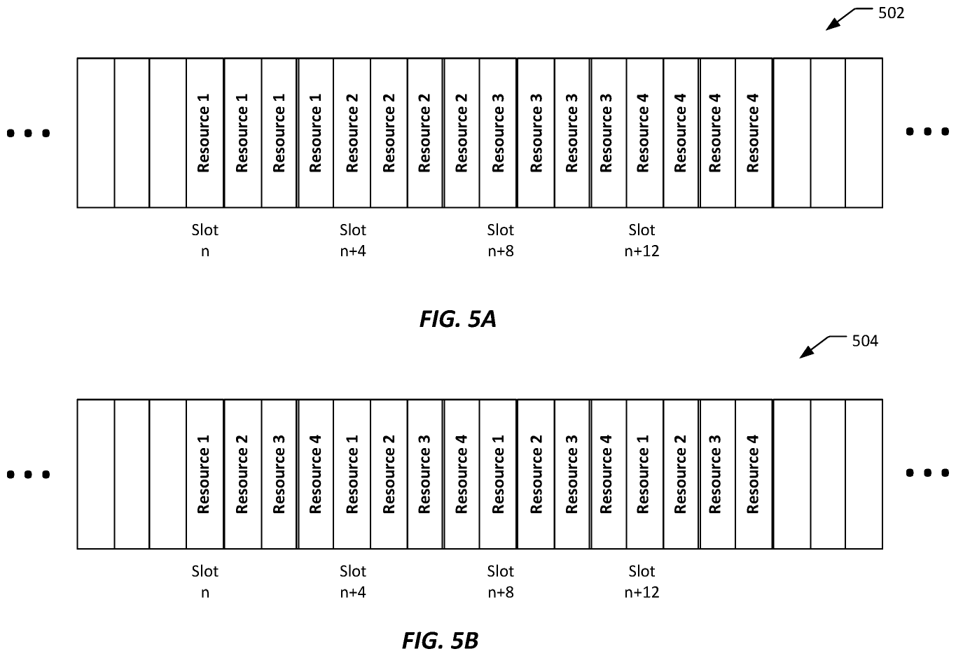

Referring to FIGS. 5A and 5B, example downlink PRS resource sets are shown. In general, a PRS resource set is a collection of PRS resources across one base station (e.g., TRP 300) which have the same periodicity, a common muting pattern configuration and the same repetition factor across slots. A first PRS resource set 502 includes 4 resources and a repetition factor of 4, with a time-gap equal to 1 slot. A second PRS resource set 504 includes 4 resources and a repetition factor of 4 with a time-gap equal to 4 slots. The repetition factor indicates the number of times each PRS resource is repeated in each single instance of the PRS resource set (e.g., values of 1, 2, 4, 6, 8, 16, 32). The time-gap represents the offset in units of slots between two repeated instances of a PRS resource corresponding to the same PRS resource ID within a single instance of the PRS resource set (e.g., values of 1, 2, 4, 8, 16, 32). The time duration spanned by one PRS resource set containing repeated PRS resources does not exceed PRS-periodicity. The repetition of a PRS resource enables receiver beam sweeping across repetitions and combining RF gains to increase coverage. The repetition may also enable intra-instance muting.

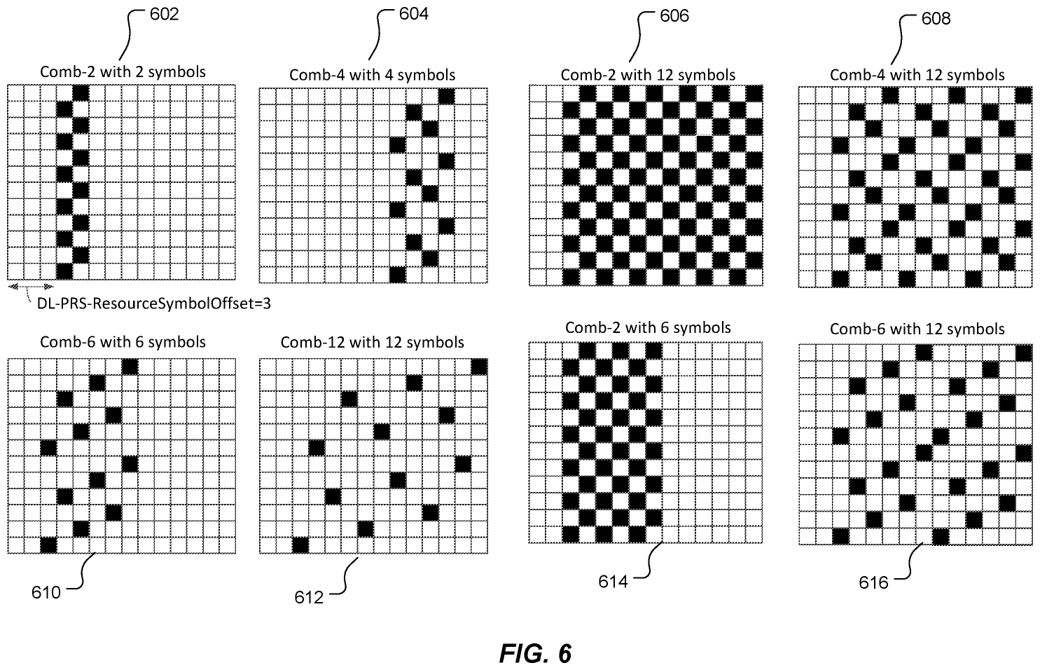

Referring to FIG. 6, example subframe and slot formats for positioning reference signal transmissions are shown. The example subframe and slot formats are included in the PRS resource sets depicted in FIGS. 5A and 5B. The subframes and slot formats in FIG. 6 are examples and not limitations and include a comb-2 with 2 symbols format 602, a comb-4 with 4 symbols format 604, a comb-2 with 12 symbols format 606, a comb-4 with 12 symbols format 608, a comb-6 with 6 symbols format 610, a comb-12 with 12 symbols format 612, a comb-2 with 6 symbols format 614, and a comb-6 with 12 symbols format 616. In general, a subframe may include 14 symbol periods with indices 0 to 13. The subframe and slot formats may be used for a Physical Broadcast Channel (PBCH). Typically, a base station may transmit the PRS from antenna port 6 on one or more slots in each subframe configured for PRS transmission. The base station may avoid transmitting the PRS on resource elements allocated to the PBCH, a primary synchronization signal (PSS), or a secondary synchronization signal (SSS) regardless of their antenna ports. The cell may generate reference symbols for the PRS based on a cell ID, a symbol period index, and a slot index. Generally, a UE may be able to distinguish the PRS from different cells.

A base station may transmit the PRS over a particular PRS bandwidth, which may be configured by higher layers. The base station may transmit the PRS on subcarriers spaced apart across the PRS bandwidth. The base station may also transmit the PRS based on the parameters such as PRS periodicity TPRS, subframe offset PRS, and PRS duration NPRS. PRS periodicity is the periodicity at which the PRS is transmitted. The PRS periodicity may be, for example, 160, 320, 640 or 1280 ms. Subframe offset indicates specific subframes in which the PRS is transmitted. And PRS duration indicates the number of consecutive subframes in which the PRS is transmitted in each period of PRS transmission (PRS occasion). The PRS duration may be, for example, 1, 2, 4 or 6 ms.

The PRS periodicity TPRS and the subframe offset PRS may be conveyed via a PRS configuration index IPRS. The PRS configuration index and the PRS duration may be configured independently by higher layers. A set of NPRS consecutive subframes in which the PRS is transmitted may be referred to as a PRS occasion. Each PRS occasion may be enabled or muted, for example, the UE may apply a muting bit to each cell. A PRS resource set is a collection of PRS resources across a base station which have the same periodicity, a common muting pattern configuration, and the same repetition factor across slots (e.g., 1, 2, 4, 6, 8, 16, 32 slots).

In general, the PRS resources depicted in FIGS. 5A and 5B may be a collection of resource elements that are used for transmission of PRS. The collection of resource elements can span multiple physical resource blocks (PRBs) in the frequency domain and N (e.g., 1 or more) consecutive symbol(s) within a slot in the time domain. In a given OFDM symbol, a PRS resource occupies consecutive PRBs. A PRS resource is described by at least the following parameters: PRS resource identifier (ID), sequence ID, comb size-N, resource element offset in the frequency domain, starting slot and starting symbol, number of symbols per PRS resource (i.e., the duration of the PRS resource), and QCL information (e.g., QCL with other DL reference signals). The comb size indicates the number of subcarriers in each symbol carrying PRS. For example, a comb-size of comb-4 means that every fourth subcarrier of a given symbol carries PRS.

A PRS resource set is a set of PRS resources used for the transmission of PRS signals, where each PRS resource has a PRS resource ID. In addition, the PRS resources in a PRS resource set are associated with the same transmission-reception point (e.g., a TRP 300). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. Note that this does not have any implications on whether the base stations and the beams on which PRS are transmitted are known to the UE.

In an example, a positioning frequency layer may be a collection of PRS resource sets across one or more base stations. The positioning frequency layer may have the same subcarrier spacing (SCS) and cyclic prefix (CP) type, the same point-A, the same value of DL PRS Bandwidth, the same start PRB, and the same value of comb-size. The numerologies supported for PDSCH may be supported for PRS.

A PRS occasion is one instance of a periodically repeated time window (e.g., a group of one or more consecutive slots) where PRS are expected to be transmitted. A PRS occasion may also be referred to as a PRS positioning occasion, a positioning occasion, or simply an occasion.

Note that the terms positioning reference signal and PRS are reference signals that can be used for positioning, such as but not limited to, PRS signals in LTE, navigation reference signals (NRS) in 5G, downlink position reference signals (DL-PRS), uplink position reference signals (UL-PRS), tracking reference signals (TRS), cell-specific reference signals (CRS), channel state information reference signals (CSI-RS), primary synchronization signals (PSS), secondary synchronization signals (SSS), sounding reference signals (SRS), etc.

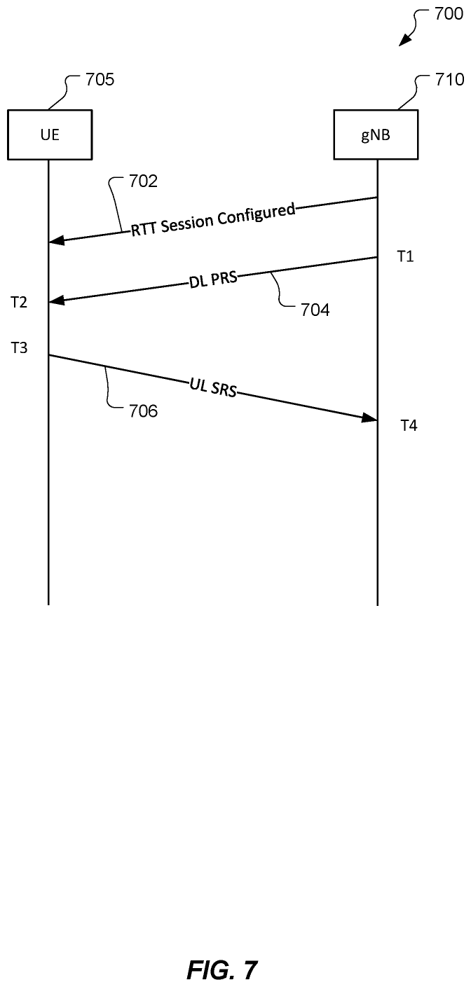

Referring to FIG. 7, an example round trip message flow 700 between a user equipment 705 and a base station 710 is shown. The UE 705 is an example of the UE 105, 200 and the base station 710 may be a gNB 110a-b or ng-eNB 114. In general, RTT positioning methods utilize a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. The example message flow 700 may be initiated by the base station 710 with a RTT session configured message 702. The base station may utilize the LPP/NRPPa messaging to configure the RTT session. At time T1, the base station 710 may transmit a DL PRS 704, which is received by the UE 705 at time T2. In response, the UE 705 may transmit a Sounding Reference Signal (SRS) for positioning message 706 at time T3 which is received by the base station 710 at time T4. The distance between the UE 705 and the base station 710 may be computed as:

$$distance = \frac{c}{2} ( ( T 4 - T 1 ) - ( T 3 - T 2 ) ) \qquad ( 1 )$$

$$where$$

$$c = speed of light .$$

In dense operating environments, where there are many UEs exchanging RTT messages with base stations, the bandwidth required for the UL Sounding Reference Signals (SRS) for positioning messages may increase the messaging overhead and utilize excess network bandwidth. Passive positioning techniques may reduce the bandwidth required for positioning by eliminating transmissions from the UE.

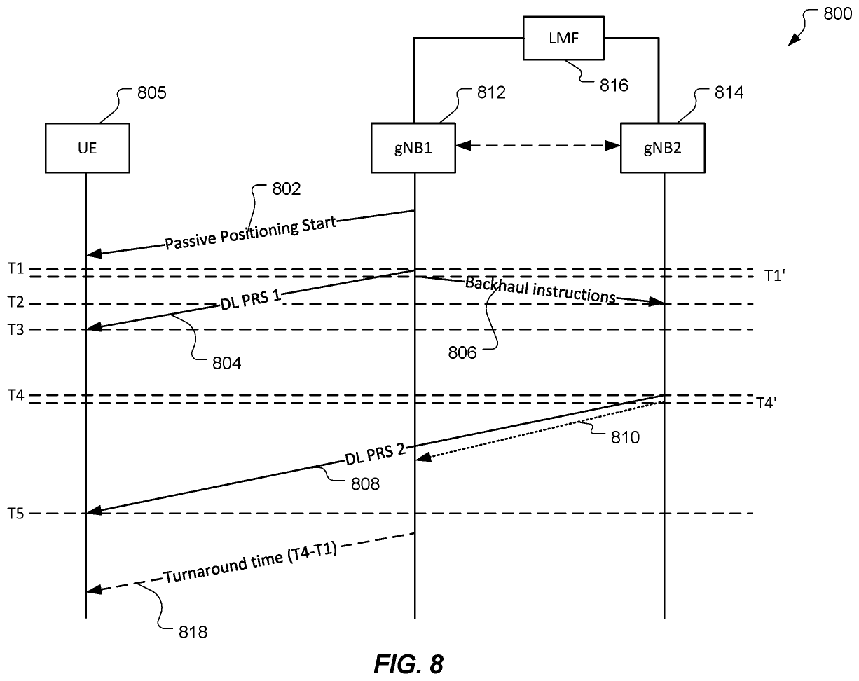

Referring to FIG. 8, an example message flow 800 for on-demand passive positioning of a user equipment 805 with backhaul messaging is shown. The message flow includes the UE 805, a first base station 812, a second base station 814, and a LMF 816. The UE 805 is an example of the UEs 105, 200, and the base stations 812, 814 are examples of the gNBs 110a-b or ng-eNB 114. The LMF 816 may include some or all of the components of the server 400, and the server 400 is an example of the LMF 816. In general, TDOA positioning techniques utilize the difference in travel times between one entity and other entities to determine relative ranges from the other entities and those, combined with known locations of the other entities may be used to determine the location of the one entity. Angles of arrival and/or departure may be used to help determine a location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). In operation, the first base station 812 may provide a passive positioning start message 802 to the UE 805. The passive positioning start message 802 may be a broadcast message, or other signaling such as RRC, to inform the UE of a PRS transmission schedule and may include transmission information (e.g., channel information, muting patterns, PRS bandwidth, PRS identification information, etc.). At time T1, the first base station 812 may transmit a first DL PRS 804 which may be received by the UE 805 at time T3. The first base station 812 also sends one or more backhaul instruction messages 806 to the second base station 814 including information for transmitting a second DL PRS 808. The backhaul instruction messages 806 may be routed via the LMF 816, or sent directly to the second base station 814 (e.g., via the X2 communication link). The backhaul instruction messages 806 may be sent in coordination with the transmission of the first DL PRS 804, such as at time T1 or within a delay period (e.g., at time T1′ within 100 ms of T1). The second base station 814 receives the backhaul instruction messages 806 at time T2 and transmits the second DL PRS 808 at time T4. The time T4 may be a previously determined time (e.g., based on a network slot plan). In an example, the backhaul instructions may include an indication of T1 and timing offset information based on any timing differences between the first and second base stations 812, 814. The second DL PRS 808 is received by the UE 805 at time T5. The time between T2 and T4 may be a configured turnaround time on the second base station 814 and thus a known period of time. The time between T1 and T2 may also be known because the first and second base stations 812, 814 may report timing information including T1, T2 and timing offsets to the LMF 816. The second station delay time (i.e., T4−T2) and the backhaul message time (i.e., T2−T1) may be used to determine a turnaround time value (e.g., T4−T1), which may be broadcast or otherwise provided to the UE 805 for use in positioning calculations. For example, when the UE 805 is in an RRC connected state, the turnaround time and station location information may be provided via broadcast, PDSCH, PDCCH, MAC-CE, RRC messages, or other signaling methods. In an embodiment, the value of the turnaround time (i.e., T4−T1) may be dominated by the periodicity of the PRS and thus may be relaxed to a known upper bound of the propagation delay. When the UE 805 is in an RRC idle or inactive mode, the turnaround time and time of flight information may be provided via System Information Blocks (e.g., SIBs, pos-SIBs) or Other System Information (OSI) messaging. The UE 805 may observe the difference between T6 and T3, and the distances may be computed as:

$${D}_{gNB 1 - UE} = c ( {T}_{3} - {T}_{1} ) \qquad ( 2 )$$

$${D}_{gNB 2 - UE} = c ( ( {T}_{5} - {T}_{1} ) - ( {T}_{4} - {T}_{2} ) - ( {T}_{2} - {T}_{1} ) ) = c ( {T}_{5} - {T}_{4} ) \qquad ( 3 )$$

$${D}_{gNB 2 - UE} - {D}_{gNB 1 - UE} = c ( ( {T}_{5} - {T}_{3} ) - ( {T}_{4} - {T}_{1} ) ) \qquad ( 4 )$$

The distance values and the locations of the stations may be used to determine a location of the UE 805. In an example, the UE 805 may provide the distance information to a network resource (e.g., the LMF 816) and the network may be configured to determine the location of the UE 805. In another example, the UE 805 may receive assistance data and be configured to determine a location and report the location to the network. The base stations 812, 814 may be configured to operate with different radio access technologies (e.g., LTE, sub 6 GHz, 5G, mmW) and with different frequency layers. In an example, in dynamic spectrum sharing, the base stations and/or UEs may be configured to operate with different technologies simultaneously.

The second base station 814 may be configured to send an optional backhaul message 810 to the first base station 812 and/or the LMF 816 to indicate the T2 and/or T4 times. The first base station 812 may be configured to provide one or more turnaround time messages 818 to the UE 805 to provide an indication of the T4-T1 turnaround time. In an example, the T4-T1 information may be included in assistance data associated with the passive positioning start message 802. The timing difference information may be based on predefined granularity, such as a difference is system frame numbers or slot indices. The UE 805 may be configured to determine the timing difference (e.g., T4-T1) to a finer granularity based on configurations such as the symbols of PRS within a slot/frame.

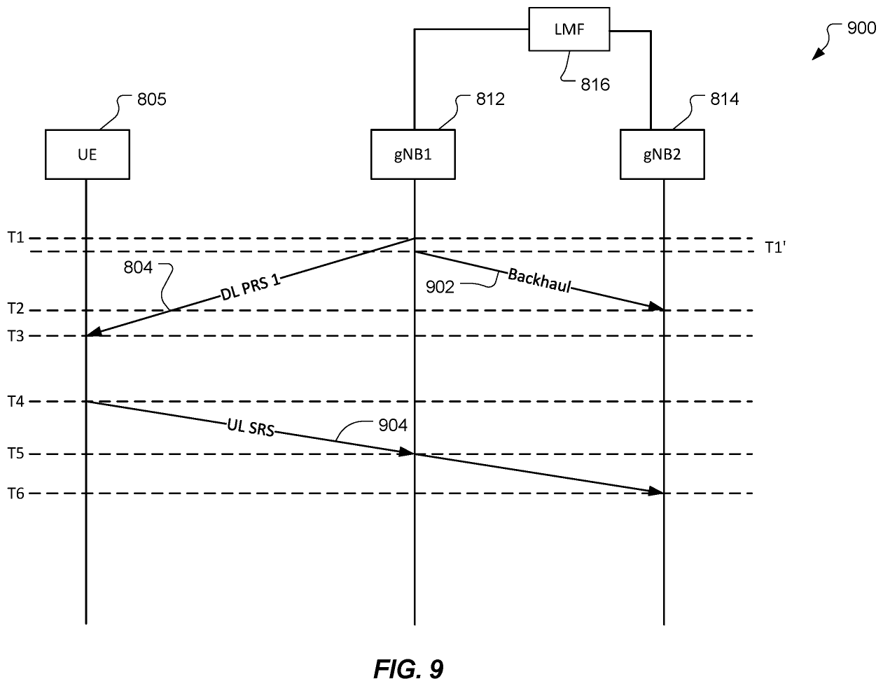

Referring to FIG. 9, with further reference to FIG. 8, an example message flow 900 for on-demand positioning of a UE 805 with backhaul messages is shown. The first base station 812 may provide backhaul messages 902 to the second base station 814 indicating the time a first DL PRS 804 is transmitted (i.e., T1), and a time T4 when the UE 805 is schedule to transmit an UL SRS for positioning 904. In operation, the UE 805 may provide the UL SRS for positioning 904 in response to receiving the first DL PRS 804. The UE 805 may be configured to provide the turnaround time (i.e., T4-T3) to the first base station 812, or another station on the network, and the second base station may be configured to determine a ToA based on the receipt of the UL SRS for positioning 904 at time T6.

The LMF 816 may configure the PRS transmissions and signal the PRS configurations to the base stations in a network. In an example, the LMF 816 may be configured to inform network stations of the PRS timing information (e.g., inter-gNB propagation, gNB turn times, etc.). The UEs in the network may measure the PRS transmitted from the base stations and utilize the PRS timing information to determine time differences between the PRS signals. The time differences may be used in the position computations. In an embodiment, the PRS timing information may include timing offset values for base station pairs, or other time reference such as a GNSS time. The timing information may also include periodicity information and resources for PRS of the base stations, and propagation times among base stations. In an example, the propagation times may be defined as upper bounds instead of accurate values. The timing information may enable a UE to receive a PRS from a master base station and then determine T4−T1 values for other base stations, which may be variable based on when the master PRS is transmitted and the backhaul messages are sent to the other base stations. The timing information may be propagated via inter-gNB message exchanges (e.g., direct data connection and message transfer between the gNBs), and/or via connections through the LMF 816 (e.g., the LMF 816 may be configured to distribute the timing information to other gNBs). Other signaling techniques may also be used to propagate the timing information.

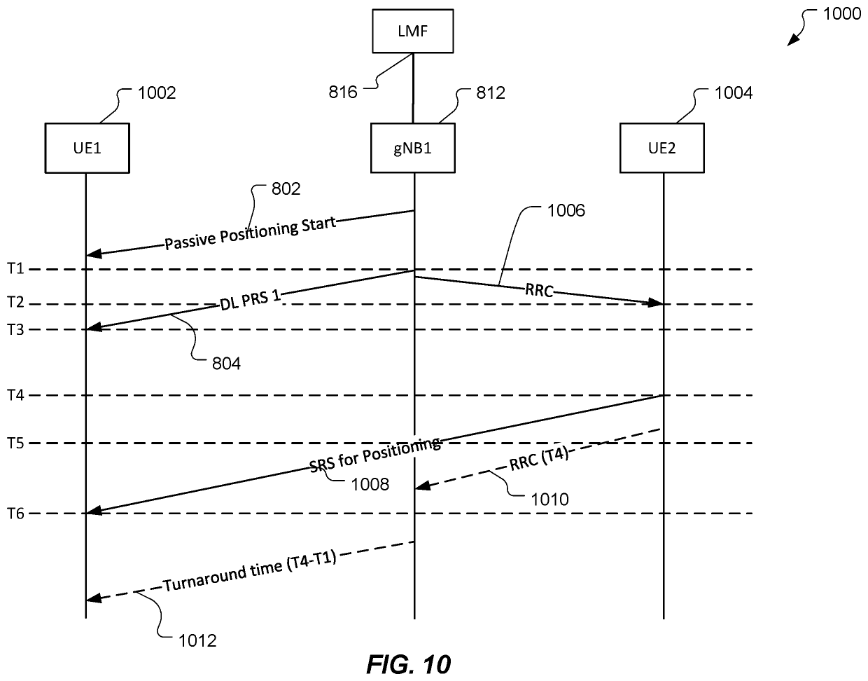

Referring to FIG. 10, an example message flow 1000 for on-demand passive positioning of a first UE 1002 with a base station 812 and a second UE 1004 is shown. The message flow 1000 includes the first base station 812, the LMF 816, the first UE 1002, and the second UE 1004. The UEs 1002, 1004 are examples of the UEs 105, 200. The message flow 1000 is similar to message flow 800 with the exception of the second UE 1004 is performing as the second base station 814, and the first base station 812 is providing instructions to the second UE 1004 via OTA RRC messaging. In an example, the message flow 1000 includes providing a passive positioning start message 802 to the first UE 1002. The passive positioning start message 802 may include assistance data including PRS and SRS configuration information (e.g., PRS resources, T1, T4, turnaround times, slot/frame information, etc.). The first base station 812 may transmit a DL PRS 804 at time T1, which is received by the first UE 1002 at time T3. The first base station 812 also provides instructions 1006 to the second UE 1004 to transmit SRS for positioning at a predefined time, or in predefined slots/frames. The instructions 1006 may be transmitted concurrently with the DL PRS 804, or within a operational delay period from T1 (e.g., 1-100 ms). The instructions 1006 may be provided via RRC messaging. In an example, for RRC_connected UEs, the instructions 1006 can be provided via (broadcast) PDSCH, PDCCH, MAC-CE, RRC messages etc. For RRC idle or RRC inactive UEs, the configurations can be provided via SIBs (OSI or pos-SIB etc.). The second UE 1004 is configured to transmit an UL PRS or UL SRS 1008 at time T4, which may be received by the first base station 812 at time T5. In an example, the second UE 1004 may utilize an optional RRC message 1010 to provide an indication of the T4 time to the first base station 812. The first UE 1002 is in a position to receive the UL SRS 1008 at time T6. The first base station 812 may be configured to indicate (e.g., via broadcasting or other signaling) the turnaround time (i.e., T4−T1), and other assistance data (e.g., locations of the first base station 812 and the second UE 1004). In an example, the first base station 812 may indicate the turnaround time (T4−T1) via one or more turnaround time messages 1012. Other signaling techniques may also be used. The first UE 1002 is configured to perform RSTD measurements based on the time of arrivals T3 and T6 and compute distances between the stations based on the equations (2)-(4) above. While FIG. 10 depicts two UEs and one base station, the methods for passive positioning with NR described herein are not so limited. Various combinations of base stations and UEs may be used. Further, the base stations may be one or more of a variety of TRPs such as macro, pico and/or femto TRPs, and combinations of omnidirectional and beamformed transmissions may be used. Different frequency layers and different radio access technologies may also be used. For example, the first base station 812 may be configured to transmit PRS based on LTE and/or 5G standards in a dynamic spectrum sharing model, and the UEs may be configured to transmit PRS/SRS based on either LTE and/or 5G based on the individual capabilities of the UEs.

In an example, a designated reference UE (e.g., the second UE 1004) may not have a line of sight (NLOS) with the first base station 812 and may be configured to perform an RTT exchange with the first base station 812. The resulting RTT distance may be provided to the first UE 1002 and used as a proxy for the distance/time of flight between the first base station 812 and the reference UE (e.g., the second UE 1004).

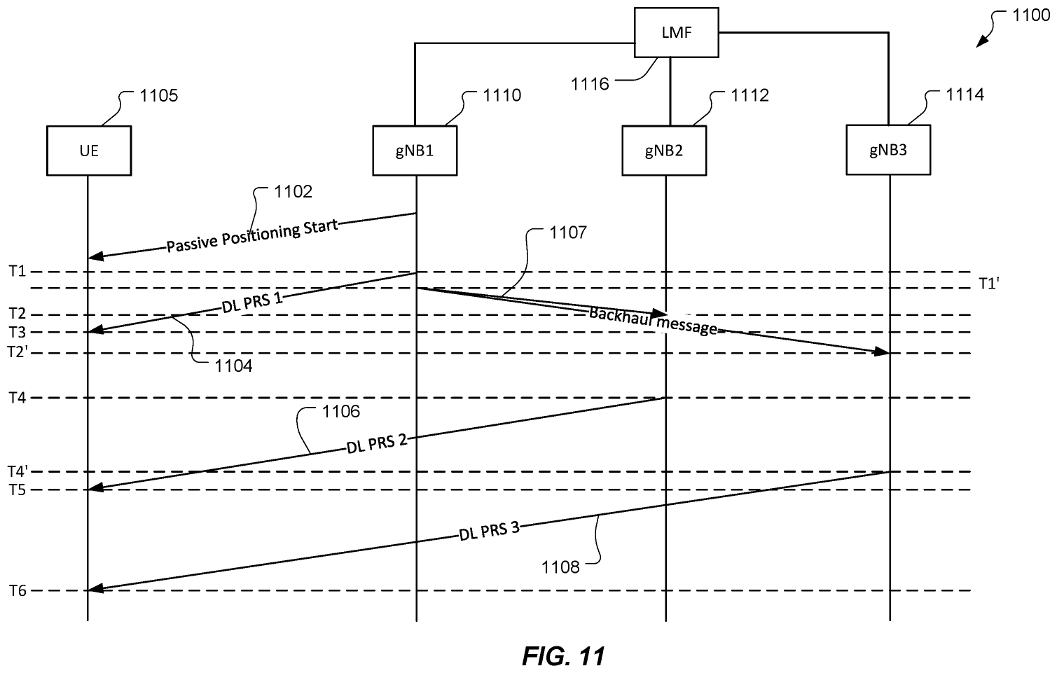

Referring to FIG. 11, an example message flow 1100 for on-demand passive positioning of a user equipment with a plurality of base stations is shown. The message flow includes a UE 1105, a first base station 1110, a second base station 1112, third base station 1114, and a LMF 1116. The UE 1105 is an example of the UEs 105, 200, and the base stations 1110, 1112, 1114 are examples of the gNBs 110a-b or ng-eNB 114. The number of UEs and base stations in FIG. 11 are examples and not limitations as various numbers of UEs and base stations may be used. The first base station 1110 may optionally provide a passive positioning start message 1102. The passive positioning start message 1102 may be a broadcast message, or other signaling such as RRC, to inform the UE 1105, or other proximate UEs (not shown in FIG. 11) of PRS transmission schedules for each of the base stations 1110, 1112, 1114, which may include respective transmission information for each of the base stations (e.g., resource sets, resources, times, frequencies, resource elements per resource, repetition factor, periodicity, offset, etc.). At time T1, the first base station 1110 may transmit a first DL PRS 1104 which may be received by the UE 1105 at time T3. The first base station 1110 may also send one or more backhaul messages 1107 to the second and third base stations 1112, 1114 indicating times to transmit a second DL PRS 1106 and a third DL PRS 1108, respectively. The backhaul messages 1107 may be sent approximately at the same time as the first DL PRS 1104 (e.g., within 100 ms). The second base station 1112 may be configured to transmit the second DL PRS 1106 at time T4, which is received by the UE 1105 at time T5. The time between T1 and T4 may be a configured turnaround time on the second base station 1112 and thus a known period of time. In an example, the LMF 1116 may be configured to determine the T4−T1 time period. The first turnaround time (i.e., T4−T1) may be broadcast or otherwise provided to the UE 1105 for use in positioning calculations. The third base station 1114 is configured to transmit a third DL PRS 1108 at time T4′, which is received by the UE 1105 at time T6. The time between T1 and T4′ may be a configured time on the third base station 1114 and thus a known time. The LMF 1116 may be configured to determine the time between T1 and T4′. The turnaround times (i.e., T4−T1, T4′−T1) may be provided to the UE 1105 (e.g., PDSCH, PDCCH, MAC-CE, RRC messages, SIBs, pos-SIBs, OSI, or other signaling methods). The UE 1105 may observe the difference between T5 and T3, T6 and T3, and T6 and T5. In an example, the UE 1105 may be configured to compute the respective distances based on equations (2)-(4) above and provide the distance values to the network (e.g., the LMF 1116). The network may utilize the distance values to compute a location of the UE 1105. In an example, the UE 1105 may utilize the distance values and assistance data to compute a location. The base stations 1110, 1112, 1114 may be configured to operate with different radio access technologies (e.g., LTE, sub 6 GH, 5G, mmW) and with different frequency layers. In an example, in dynamic spectrum sharing, the base stations and/or UEs may be configured to operate with different technologies simultaneously. The turnaround times (e.g., T4-T1, T4′−T1) may be configured by a network resource (e.g., the LMF 1116) and provided to the respective base stations to enable the DL PRS 1104, 1106, 1108 to be transmitted in a preestablished sequence. The base stations 1110, 1112, 1114 may also be configured with periods of null resources (e.g., muted) to avoid interference with proximate stations. In an example, the DL PRS 1104, 1106, 1108 may be transmitted on different frequency layers and with different technologies (e.g., LTE, 5G). One or more of the base stations 1110, 1112, 1114, may be a UE (e.g., a reference UE) configured to transmit UL SRS via an UL interface (e.g., Uu) or a sidelink interface (e.g., PC5).

In an example, the LMF 1116, or another network resource, may configure a set of gNBs (e.g., base stations 1110, 1112, 1114) to participate in a positioning session. For each set of gNBs, the LMF 1116 may configure a node to start the session and the order in which other nodes can respond to the first gNB's transmission. This enables a sequence of transmissions and allows the UE 1105 to obtain multiple reference signal measurements. The LMF 1116 may be configured to choose a different gNB to start the session at a different time (e.g., and may cycle through different combinations of the gNBs). In an example, some of the participating gNBs could be UEs, or IABs (Integrated Access-Backhaul nodes).

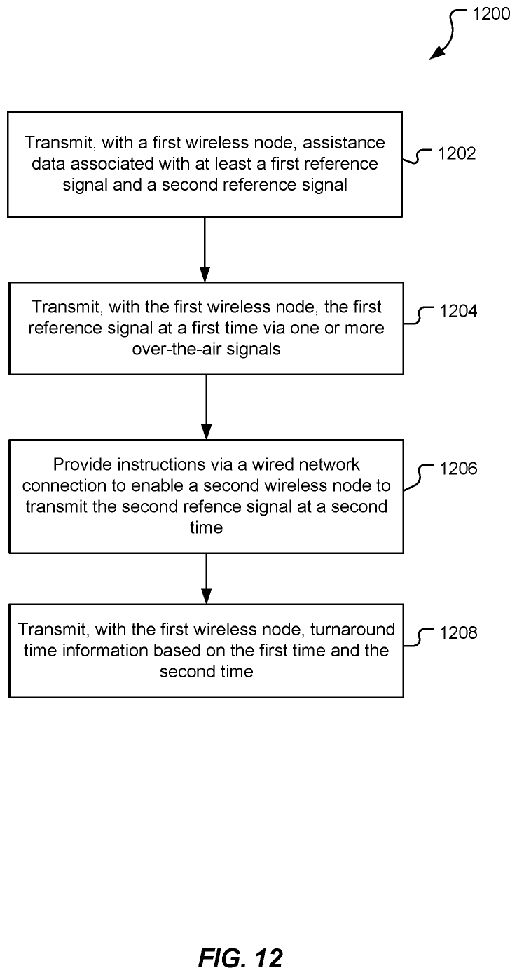

Referring to FIG. 12, with further reference to FIGS. 1-11, a method 1200 for providing passive positioning information includes the stages shown. The method 1200 is, however, an example and not limiting. The method 1200 may be altered, e.g., by having stages added, removed, rearranged, combined, performed concurrently, and/or having single stages split into multiple stages.

At stage 1202, the method includes transmitting, with a first wireless node, assistance data associated with at least a first reference signal and a second reference signal. A TRP 300, such as the first base station 812, including a processor 310 and a transceiver 315, is a means for transmitting assistance data. In an example, the first wireless node may be the first base station 812 and the assistance data may be included in a passive positioning start message 802. Other signaling techniques may be used to provide the assistance data to one or more UEs (e.g., PDSCH, PDCCH, MAC-CE, RRC messages, SIBs, pos-SIBs, OSI, or other signaling methods). The assistance data may include PRS configuration, station location, and timing information associated with the first and second reference signals. In an example, the times T1 and T4 and/or the turnaround time (e.g., T4−T1) may be included in the assistance data. The assistance data may include resource sets, resources, time and frequency information, resource elements per resource, repetition factor, periodicity, offset, and other configuration information associated with the first and second reference signals. The configuration may also indicate a mechanism to end the PRS transmission (e.g., time based, or message based), and null resources (e.g., for listening) specified after each transmission.

At stage 1204, the method includes transmitting, with the first wireless node, the first reference signal at a first time via one or more over-the-air (OTA) signals. The TRP 300, including the processor 310 and the transceiver 315, is a means for transmitting the one or more OTA signals. In an example, the first reference signal is a DL PRS, such as the first DL PRS 804 transmitted by the first base station 812 at time T1. The reference signal may be based on a PRS resource set and/or positioning frequency layer. In an example, other reference signal such as TRS, CRS and CSI-RS may be used.

At stage 1206, the method includes providing instructions via a wired network connection to enable a wireless node to transmit the second reference signal at a second time. The TRP 300, including the processor 310 and the transceiver 315, is a means for providing the instructions. In an example, the backhaul instruction messages 806 may be transmitted over the X2 interface which may be directly between the stations (e.g., the first and second base stations 812, 814), or via the core network and then to the second base station 814 (i.e., an X2 interface may be implemented by a network topology in which messages between gNBs pass through the core network). The instructions may include an indication of T4, or a nominal T4−T1, for the wireless node (i.e., the second base station 814) to transmit the second reference signal.

At stage 1208, the method includes transmitting, with the first wireless node, turnaround time information based on the first time and the second time. The TRP 300, including the processor 310 and the transceiver 315, is a means for transmitting the turnaround time information. In an example, the first base station 812 may transmit a turnaround time message 818 including the turnaround time information. The turnaround time information may be the actual value of T4−T1 based on the transmission times and correction factors of the first and second reference signals. The LMF 816 may provide a correction factor to calibrate the timing between the first and second base stations 812, 814. In an example, the UE 805 may be provided with the timing differences and a nominal timing offset and the UE 805 may be configured to derive the actual T4−T1 value.

In an embodiment, the functions of the first wireless node in the method 1200 may be performed by reference UEs, and the backhaul instruction messages may utilize sidelink protocols. For example, UL PRS and device-to-device sidelinks (e.g., PC5) may be used to provide PRS or other reference information. In an example, the wireless node may be a roadside unit (RSU) in a vehicle-to-everything (V2X) network. The RSU may be configured to receive instructions to transmit the second reference signal from a gNB via a wired connection, and then transmit the reference signals to a UE via sidelink. Other interfaces, such as the Uu interface, may be used to transmit reference signal instructions.

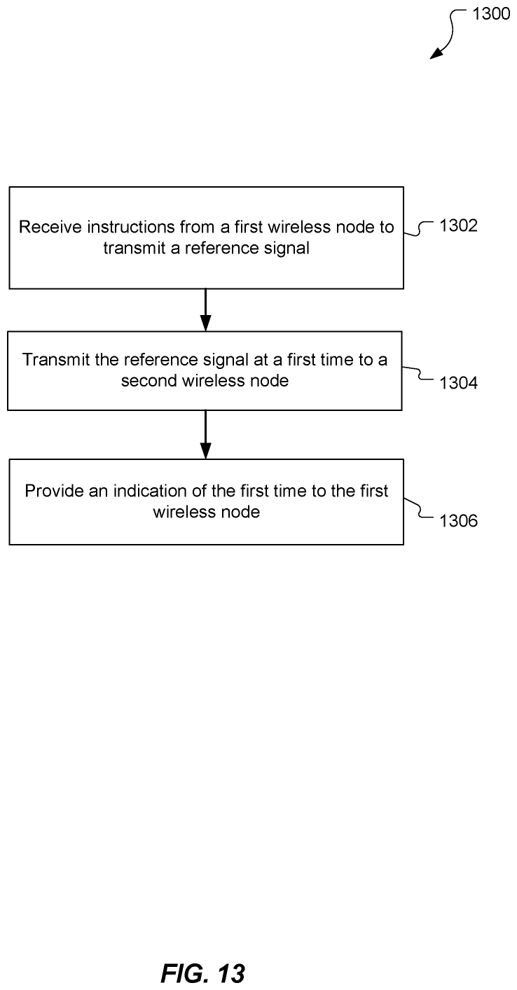

Referring to FIG. 13, with further reference to FIGS. 1-11, a method 1300 for providing on-demand reference signals includes the stages shown. The method 1300 is, however, an example and not limiting. The method 1300 may be altered, e.g., by having stages added, removed, rearranged, combined, performed concurrently, and/or having single stages split into multiple stages.

At stage 1302, the method includes receiving instructions from a first wireless node to transmit a reference signal. In an example, a TRP 300 including a processor 310 and a transceiver 315 is a means for receiving instructions to transmit a reference signal. In an example, a UE 200 including one or more processors 210 and a transceiver 215 is a means for receiving instructions to transmit the reference signal. A first wireless node, such as the first base station 812, may be configured to provide instructions to another network station such as a gNB (e.g., the second base station 814), or a UE (e.g., the second UE 1004). In an example, the instructions may be received via a backhaul connection (e.g., X2 interface) sent directly from the wireless node, or via the core network. In an example, the instructions may be received via over-the-air messages. RRC_connected UEs may receive the instructions via broadcast, PDSCH, PDCCH, MAC-CE, RRC messages etc. RRC idle or RRC_inactive UEs may receive the instructions via SIBs (OSI or pos-SIB etc.). The instructions may include an indication of T4, or a nominal T4−T1, to transmit the reference signal.

At stage 1304, the method includes transmitting the reference signal at a first time to a second wireless node. The TRP 300 and the UE 200 are means for transmitting the reference signal. In an example, a TRP 300, such as the second base station 814, may be configured to transmit DL PRS at a specific time and/or at a specified slot/frame to a second wireless node such as the UE 805. The reference signal may be the second DL PRS 808 transmitted at time T4. In an example, a UE 200, such as the UE 1004, may be configured to transmit a SRS for positioning signal at a specific time and/or at a specified slot/frame to a second wireless node, such as the UE 1002. The reference signal may be the UL SRS 1008 transmitted at time T4. In an example, the reference signal may be a sidelink positioning reference signal (SL PRS) utilizing a sidelink protocol.

At stage 1306, the method includes providing an indication of the first time to the first wireless node. The TRP 300 and the UE 200 are means for providing the indication of the first time. The TRP 300 may be configured to utilize the backhaul to send a message to the wireless node indicating the T4 time. For example, referring to FIG. 8, the second base station 814 may send the optional backhaul message 810 to the wireless node. The UE 200 may utilize RRC messaging, such as the optional RRC message 1010, to provide the first time (e.g., time T4) to the wireless node. Other signaling techniques, such as sidelink, may be used

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in the LMF 120 may be performed outside of the LMF 120 such as by the TRP 300.

Components, functional or otherwise, shown in the figures and/or discussed herein as being connected or communicating with each other are communicatively coupled unless otherwise noted. That is, they may be directly or indirectly connected to enable communication between them.

As used herein, unless otherwise stated, a statement that a function or operation is “based on” an item or condition means that the function or operation is based on the stated item or condition and may be based on one or more items and/or conditions in addition to the stated item or condition.

As used herein, the singular forms “a,” “an,” and “the” include the plural forms as well, unless the context clearly indicates otherwise. For example, “a processor” may include one processor or multiple processors. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure). Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for providing passive positioning information, comprising: transmitting, with a first wireless node, assistance data associated with at least a first reference signal and a second reference signal; transmitting, with the first wireless node, the first reference signal at a first time via one or more over-the-air signals; providing instructions via a wired network connection to enable a second wireless node to transmit the second reference signal at a second time; and transmitting, with the first wireless node, turnaround time information based on the first time and the second time.

Clause 2. The method of clause 1 wherein the first reference signal and the second reference signal are downlink positioning reference signals.

Clause 3. The method of clause 1 wherein the assistance data is transmitted via one or more radio resource control messages.

Clause 4. The method of clause 1 wherein the assistance data is included in one or more system information blocks.

Clause 5. The method of clause 1 wherein the turnaround time information is included in the assistance data.

Clause 6. The method of clause 1 wherein the second wireless node is a transmission/reception point and the instructions are provided directly to the transmission/reception point via an X2 interface.

Clause 7. The method of clause 1 wherein the second wireless node is a transmission/reception point and the instructions are provided to the transmission/reception point via a location management function.

Clause 8. The method of clause 1 wherein the second wireless node is a roadside unit and the instructions are configured to enable the roadside unit to transmit the second reference signal via a sidelink.

Clause 9. The method of clause 1 wherein the first reference signal utilizes a first radio access technology and the second reference signal utilizes a second radio access technology that is different from the first radio access technology.

Clause 10. A method of providing on-demand reference signals, comprising: receiving instructions from a first wireless node to transmit a reference signal; transmitting the reference signal at a first time to a second wireless node; and providing an indication of the first time to the first wireless node.

Clause 11. The method of clause 10 wherein the instructions are received from the first wireless node via one or more over-the-air messages.

Clause 12. The method of clause 11 wherein the one or more over-the-air messages include radio resource control messages.

Clause 13. The method of clause 10 wherein the instructions are received via a wired network connection.

Clause 14. The method of clause 10 wherein the reference signal is a sounding reference signal for positioning.

Clause 15. The method of clause 10 wherein the reference signal is a downlink positioning reference signal.

Clause 16. The method of clause 10 wherein the reference signal is a sidelink positioning reference signal.

Clause 17. The method of clause 10 wherein providing the indication of the first time includes providing one or more over-the-air messages to the first wireless node.

Clause 18. The method of clause 10 wherein providing the indication of the first time includes providing one or more messages to the first wireless node via a wired network connection.

Clause 19. The method of clause 10 wherein the reference signal is transmitted by a gNB.

Clause 20. The method of clause 10 wherein the reference signal is transmitted by a user equipment.

Clause 21. The method of clause 10 wherein the reference signal is transmitted by an integrated access-backhaul node.

Clause 22. An apparatus, comprising: a memory; at least one transceiver; at least one processor communicatively coupled to the memory and the at least one transceiver, and configured to: transmit assistance data associated with at least a first reference signal and a second reference signal; transmitting the first reference signal at a first time via one or more over-the-air signals; provide instructions via a wired network connection to enable a wireless node to transmit the second reference signal at a second time; and transmit turnaround time information based on the first time and the second time.

Clause 23. The apparatus of clause 22 wherein the first reference signal and the second reference signal are downlink positioning reference signals.

Clause 24. The apparatus of clause 22 wherein the at least one processor is further configured to transmit the assistance data via one or more radio resource control messages.

Clause 25. The apparatus of clause 22 wherein the at least one processor is further configured to transmit the assistance data in one or more system information blocks.

Clause 26. The apparatus of clause 22 wherein the turnaround time information is included in the assistance data.

Clause 27. The apparatus of clause 22 wherein the wireless node is a transmission/reception point and the at least one processor is further configured to provide instructions directly to the transmission/reception point via an X2 interface.

Clause 28. The apparatus of clause 22 wherein the wireless node is a transmission/reception point and the at least one processor is further configured to provide instructions to the transmission/reception point via a location management function.

Clause 29. The apparatus of clause 22 wherein the wireless node is a roadside unit and the instructions are configured to enable the roadside unit to transmit the second reference signal via a sidelink.

Clause 30. The apparatus of clause 22 wherein the first reference signal utilizes a first radio access technology and the second reference signal utilizes a second radio access technology that is different from the first radio access technology.

Clause 31. An apparatus, comprising: a memory; at least one transceiver; at least one processor communicatively coupled to the memory and the at least one transceiver, configured to: receive instructions from a first wireless node to transmit a reference signal; transmit the reference signal at a first time to a second wireless node; and provide an indication of the first time to the first wireless node.

Clause 32. The apparatus of clause 31 wherein the at least one processor is further configured to receive the instructions from the first wireless node via one or more over-the-air messages.

Clause 33. The apparatus of clause 32 wherein the one or more over-the-air messages include radio resource control messages.

Clause 34. The apparatus of clause 31 wherein the at least one processor is further configured to receive the instructions via a wired network connection.

Clause 35. The apparatus of clause 31 wherein the reference signal is a sounding reference signal for positioning.

Clause 36. The apparatus of clause 31 wherein the reference signal is a downlink positioning reference signal.

Clause 37. The apparatus of clause 31 wherein the reference signal is a sidelink positioning reference signal.

Clause 38. The apparatus of clause 31 wherein the at least one processor is further configured to provide one or more over-the-air messages to the first wireless node.

Clause 39. The apparatus of clause 31 wherein the at least one processor is further configured to provide one or more messages to the first wireless node via a wired network connection.

Clause 40. The apparatus of clause 31 wherein the reference signal is transmitted by a gNB.

Clause 41. The apparatus of clause 31 wherein the reference signal is transmitted by a user equipment.

Clause 42. The apparatus of clause 31 wherein the reference signal is transmitted by an integrated access-backhaul node.

Clause 43. An apparatus for providing passive positioning information, comprising: means for transmitting, with a first wireless node, assistance data associated with at least a first reference signal and a second reference signal; means for transmitting, with the first wireless node, the first reference signal at a first time via one or more over-the-air signals; means for providing instructions via a wired network connection to enable a second wireless node to transmit the second reference signal at a second time; and means for transmitting, with the first wireless node, turnaround time information based on the first time and the second time.

Clause 44. An apparatus for providing on-demand reference signals, comprising: means for receiving instructions from a first wireless node to transmit a reference signal; means for transmitting the reference signal at a first time to a second wireless node; and means for providing an indication of the first time to the first wireless node.

Clause 45. A non-transitory processor-readable storage medium comprising processor-readable instructions configured to cause one or more processors to provide passive positioning information, comprising code for: transmitting, with a first wireless node, assistance data associated with at least a first reference signal and a second reference signal; transmitting, with the first wireless node, the first reference signal at a first time via one or more over-the-air signals; providing instructions via a wired network connection to enable a second wireless node to transmit the second reference signal at a second time; and transmitting, with the first wireless node, turnaround time information based on the first time and the second time.

Clause 46. A non-transitory processor-readable storage medium comprising processor-readable instructions configured to cause one or more processors to provide on-demand reference signals, comprising code for: receiving instructions from a first wireless node to transmit a reference signal; transmitting the reference signal at a first time to a second wireless node; and providing an indication of the first time to the first wireless node.

1. A method for providing passive positioning information, comprising:
transmitting, with a first wireless node, assistance data associated with at least a first reference signal and a second reference signal;
transmitting, with the first wireless node, the first reference signal at a first time via one or more over-the-air signals;
providing instructions via a wired network connection to enable a second wireless node to transmit the second reference signal at a second time; and
transmitting, with the first wireless node, turnaround time information based on the first time and the second time.

2. The method of claim 1 wherein the first reference signal and the second reference signal are downlink positioning reference signals.

3. The method of claim 1 wherein the assistance data is transmitted via one or more radio resource control messages.

4. The method of claim 1 wherein the assistance data is included in one or more system information blocks.

5. The method of claim 1 wherein the turnaround time information is included in the assistance data.

6. The method of claim 1 wherein the second wireless node is a transmission/reception point and the instructions are provided directly to the transmission/reception point via an X2 interface.

7. The method of claim 1 wherein the second wireless node is a transmission/reception point and the instructions are provided to the transmission/reception point via a location management function.

8. The method of claim 1 wherein the second wireless node is a roadside unit and the instructions are configured to enable the roadside unit to transmit the second reference signal via a sidelink.

9. The method of claim 1 wherein the first reference signal utilizes a first radio access technology and the second reference signal utilizes a second radio access technology that is different from the first radio access technology.

10. A method of providing on-demand reference signals, comprising:
receiving instructions from a first wireless node to transmit a reference signal;
transmitting the reference signal at a first time to a second wireless node; and
providing an indication of the first time to the first wireless node.

11. The method of claim 10 wherein the instructions are received from the first wireless node via one or more over-the-air messages.

12. The method of claim 11 wherein the one or more over-the-air messages include radio resource control messages.

13. The method of claim 10 wherein the instructions are received via a wired network connection.

14. The method of claim 10 wherein the reference signal is a sounding reference signal for positioning.

15. The method of claim 10 wherein the reference signal is a downlink positioning reference signal.

16. The method of claim 10 wherein the reference signal is a sidelink positioning reference signal.

17. The method of claim 10 wherein providing the indication of the first time includes providing one or more over-the-air messages to the first wireless node.

18. The method of claim 10 wherein providing the indication of the first time includes providing one or more messages to the first wireless node via a wired network connection.

19. The method of claim 10 wherein the reference signal is transmitted by a gNB.

20. The method of claim 10 wherein the reference signal is transmitted by a user equipment.

21. The method of claim 10 wherein the reference signal is transmitted by an integrated access-backhaul node.

22. An apparatus, comprising:
a memory;
at least one transceiver;
at least one processor communicatively coupled to the memory and the at least one transceiver, and configured to:
transmit assistance data associated with at least a first reference signal and a second reference signal;
transmitting the first reference signal at a first time via one or more over-the-air signals;
provide instructions via a wired network connection to enable a wireless node to transmit the second reference signal at a second time; and
transmit turnaround time information based on the first time and the second time.

23. The apparatus of claim 22 wherein the at least one processor is further configured to transmit the assistance data via one or more radio resource control messages.

24. The apparatus of claim 22 wherein the at least one processor is further configured to transmit the assistance data in one or more system information blocks.

25. The apparatus of claim 22 wherein the turnaround time information is included in the assistance data.

26. The apparatus of claim 22 wherein the first reference signal utilizes a first radio access technology and the second reference signal utilizes a second radio access technology that is different from the first radio access technology.

27. An apparatus, comprising:
a memory;
at least one transceiver;
at least one processor communicatively coupled to the memory and the at least one transceiver, configured to:
receive instructions from a first wireless node to transmit a reference signal;
transmit the reference signal at a first time to a second wireless node; and
provide an indication of the first time to the first wireless node.

28. The apparatus of claim 27 wherein the at least one processor is further configured to receive the instructions from the first wireless node via one or more over-the-air messages.

29. The apparatus of claim 27 wherein the at least one processor is further configured to receive the instructions via a wired network connection.

30. The apparatus of claim 27 wherein the reference signal is at least one of a sounding reference signal for positioning, a downlink positioning reference signal, and a sidelink positioning reference signal.
